(19) United States
(12) Patent Application Publication
(10) Pub. No.: US 2020/0369830 A1
(43) Pub. Date: Nov. 26, 2020

(54) POLYAMIDE ACID COMPOSITION AND METHOD FOR PRODUCING SAME, POLYIMIDE FILM, LAMINATE AND METHOD FOR PRODUCING SAME, AND FLEXIBLE DEVICE

(71) Applicant: KANEKA CORPORATION, Osaka-shi, Osaka (JP)

(72) Inventors: Ryunosuke TAKI, Otsu-shi (JP); Etsuo HORII, Otsu-shi (JP)

(73) Assignee: KANEKA CORPORATION, Osaka-shi, Osaka (JP)

(21) Appl. No.: 16/767,877

(22) PCT Filed: Dec. 17, 2018
(86) PCT No.: PCT/JP2018/046433

§ 371 Date: May 28, 2020

(30) Foreign Application Priority Data
Dec. 26, 2017 (JP) 2017-249653

(51) Int. Cl. C08G 73/10; C08G 69/28; C08L 77/00; C09D 177/00

(52) U.S. Cl. CPC C08G 73/10; C09D 177/00; C08L 77/00; C08G 69/28

(57) ABSTRACT

A polyamide acid composition contains a polyamide acid having a terminal structure represented by a general formula (1), a polyamide acid having a terminal structure represented by a general formula (2), and a polyamide acid having a terminal structure represented by a general formula (3): wherein X is a tetravalent organic group which is a tetracarboxylic acid dianhydride residue, Y is a divalent organic group which is a diamine residue, and Z is a divalent organic group which is an acid anhydride residue. A polyimide film is obtained by applying a solution of a polyamide acid on a substrate, and cyclodehydrating the polyamide acid by heating.

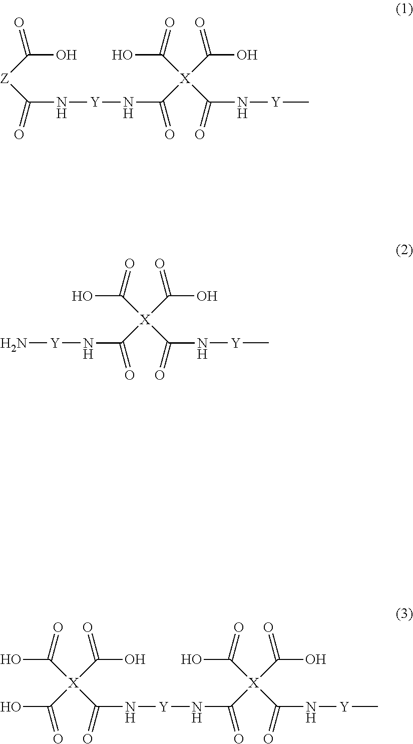

### TECHNICAL FIELD

The present invention relates to a polyamide acid composition and a method for producing the polyamide acid composition. Further, the present invention relates to a polyimide film obtained from the polyamide acid composition, a laminate in which the polyimide film is adhesively laminated on a substrate, and a device having an electronic element on the polyimide film.

### TECHNICAL BACKGROUND

A glass substrate is used as a substrate for an electronic device such as a flat panel display or an electronic paper. However, from a point of view of thickness reduction, weight reduction, flexibility, and the like, replacing a glass with a polymer film has been studied. As a polymer film material for an electronic device, a polyimide is suitable from a point of view of having excellent heat resistance and dimensional stability.

As a method for efficiently manufacturing an electronic device using a polyimide film substrate, a method has been proposed in which a laminate in which a polyimide film is adhesively laminated on a rigid substrate such as a glass is prepared and an element is formed on the polyimide film, and then, the polyimide film on which the element has been formed is peeled off from the rigid substrate. The laminate in which a polyimide film is adhesively laminated on a rigid substrate is formed by applying a solution of a polyamide acid which is a polyimide precursor on the rigid substrate and cyclodehydrating (imidizing) the polyamide acid.

The polyamide acid which is a polyimide precursor is obtained by an addition reaction between a tetracarboxylic acid dianhydride and a diamine. A polyamide acid solution tends to change in viscosity due to polymerization or depolymerization over time, and may not have sufficient storage stability. As an attempt to improve the storage stability of a polyamide acid solution, Patent Document 1 proposes a method in which a terminal of a polyamide acid is sealed with a non-reactive functional group.

### RELATED ART

### Patent Document

[Patent Document 1] International Publication No. 2012/093586.

### SUMMARY OF THE INVENTION

### Problems to be Solved by the Invention

A polyimide film used as a substrate for a flexible device is demanded to have sufficient mechanical strength. A polyamide acid of which a terminal is sealed with a non-reactive functional group does not depolymerize during imidization by heating, and thus, its molecular weight does not decrease. However, the molecular weight also does not increase. Therefore, in order to increase the mechanical strength of the polyimide film, it is necessary to increase the molecular weight of the polyamide acid. However, when the molecular weight of the polyamide acid is increased, the viscosity of the solution increases and handleability decreases.

In view of the above, the present invention is intended to provide a polyamide acid having a low solution viscosity, excellent storage stability, and sufficient mechanical strength when a polyimide film is formed.

### Means for Solving the Problems

A polyamide acid having a predetermined terminal structure can solve the above problem. A polyamide acid composition of an embodiment of the present invention contains a polyamide acid having a terminal structure represented by a general formula (1), a polyamide acid having a terminal structure represented by a general formula (2), and a polyamide acid having a terminal structure represented by a general formula (3), wherein X is a tetravalent organic group which is a tetracarboxylic acid dianhydride residue, Y is a divalent organic group which is a diamine residue, and Z is a divalent organic group which is an acid anhydride residue.

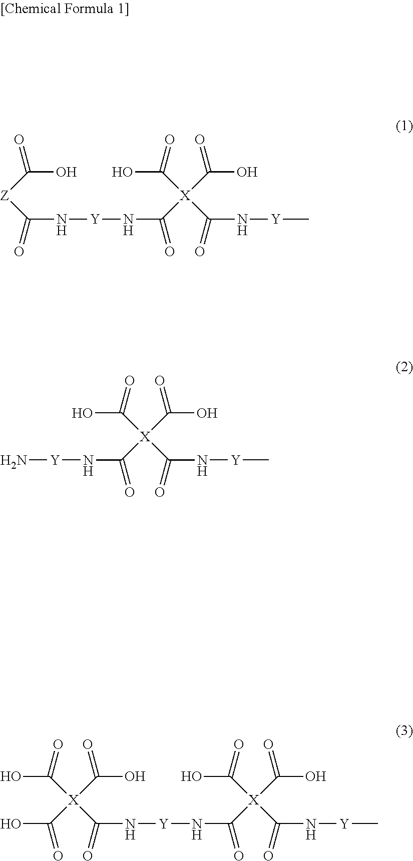

The above polyamide acid composition can be obtained, for example, through: a process in which a polyamide acid is obtained by causing a polymerization reaction to occur between a diamine and a tetracarboxylic acid dianhydride in a solvent; a process in which the polyamide acid is depolymerized by heating a solution of the polyamide acid in presence of water; and a process in which a dicarboxylic acid anhydride is caused to react with the diamine or an amine terminal of the polyamide acid.

By depolymerizing a polyamide acid in the presence of water, a polyamide acid having a terminal structure represented by the above general formula (3) is produced. Instead of depolymerization, or in addition to depolymerization, by using a single ring-opened compound of a tetracarboxylic acid dianhydride as a raw material of a polyamide acid, a polyamide acid having a terminal structure represented by the above general formula (3) can also be produced.

By causing a dicarboxylic acid anhydride to react with a diamine or an amine terminal of a polyamide acid, a polyamide acid having a terminal structure represented by the above general formula (1) is produced.

In preparing a polyamide acid composition, a ratio (x/y) of a total mole number (x) of a tetracarboxylic acid dianhydride to a total mole number (y) of a diamine is preferably 0.980-0.999. A ratio (z/y) of a total mole number (z) of a dicarboxylic acid anhydride to the total mole number (y) of the diamine is preferably 0.002-0.080. By setting the ratios of the raw materials in these ranges, a polyamide acid composition is obtained of which the ratio (x/y) of the total mole number (x) of the tetracarboxylic acid dianhydride to the total mole number (y) of the diamine is 0.980-0.999 and the ratio (z/y) of the total mole number (z) of the dicarboxylic acid anhydride to the total mole number (y) of the diamine is 0.002-0.080.

The polyamide acid composition may further contain a polyamide acid having a terminal structure represented by a general formula (4), wherein R¹ is a divalent organic group, and R² is an alkyl group having 1-5 carbon atoms.

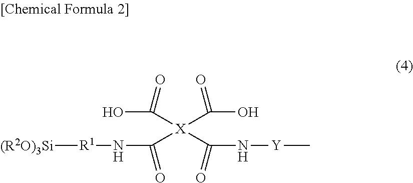

By causing an alkoxysilane compound to react with a polyamide acid to alkoxysilane-modify a terminal of a polyamide acid, a polyamide acid having a terminal structure represented by the above general formula (4) is produced. A ratio (α/x) of a total mole number (α) of the alkoxysilane compound to a total mole number (x) of the tetracarboxylic acid dianhydride is preferably 0.0001-0.0100.

A polyimide is obtained by a cyclodehydration reaction of the above polyamide acid composition. For example, by applying a solution of a polyamide acid on a substrate and imidizating the polyamide acid by cyclodehydrating the polyamide acid by heating, a laminate in which a polyimide film is adhesively laminated on the substrate is obtained. By peeling off the polyimide film from the substrate, a polyimide film is obtained.

A flexible device can be manufactured by providing an electronic element on the polyimide film. It is also possible that the electronic element is provided on the polyimide film before the polyimide film is peeled off from the laminate, and then, the polyimide film is peeled off from the laminate.

### Effect of Invention

A solution of the polyamide acid composition of the present invention has a low viscosity and is excellent in storage stability, and thus, can be easily handled. A polyimide film produced using the polyamide acid solution has excellent mechanical strength and is suitable for use as a substrate or the like for a flexible device.

### MODE FOR CARRYING OUT THE INVENTION

[Polyamide Acid Composition]

A polyamide acid is a product of a polyaddition reaction between a tetracarboxylic acid dianhydride and a diamine. The tetracarboxylic acid dianhydride is a compound represented by the following general formula (A), and the diamine is a compound represented by the following general formula (B). The polyamide acid has a repeating unit of the following general formula (P).

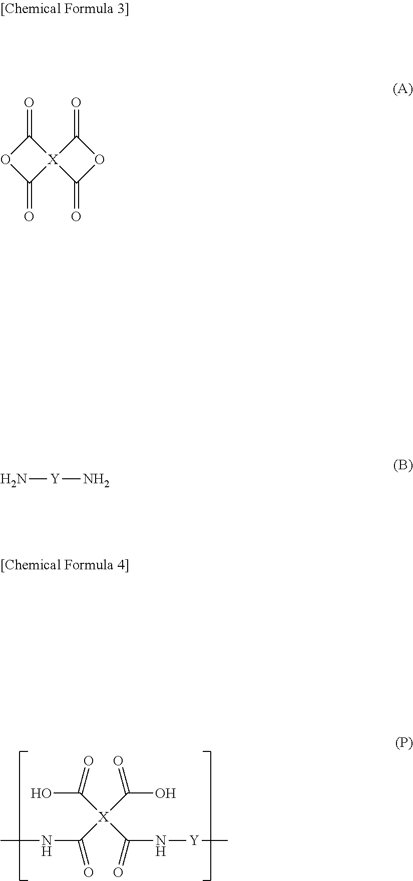

In the general formulas (A) and (P), X is a tetracarboxylic acid dianhydride residue. The tetracarboxylic acid dianhydride residue is a portion other than two acid anhydride groups (—CO—O—CO—) in the compound of the general formula (A), and is a tetravalent organic group. In the tetracarboxylic acid dianhydride, each two of four carbonyl groups bonded to X form a pair, and together with X and an oxygen atom form a five-membered ring. In the general formulas (B) and (P), Y is a diamine residue. The diamine residue is a portion other than two amino groups (—NH₂) in the compound of the general formula (B), and is a divalent organic group.

A general polyamide acid obtained by a reaction between a tetracarboxylic acid dianhydride and a diamine has a terminal structure (amine terminal) represented by the following general formula (Q) and a terminal structure (acid anhydride terminal) represented by the following general formula (R).

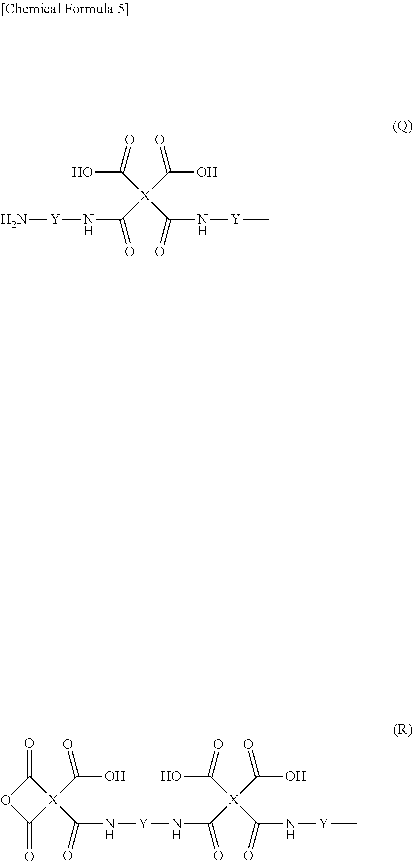

A polyamide acid composition of an embodiment of the present invention is characterized in terminal structures, and includes a terminal structure represented by a general formula (1) (a polyamide acid end-capped with an acid anhydride), a terminal structure represented by a general formula (2) (a polyamide acid of an amine terminal), and a terminal structure represented by a general formula (3) (a polyamide acid in which a terminal acid dianhydride group is hydrolytically ring-opened).

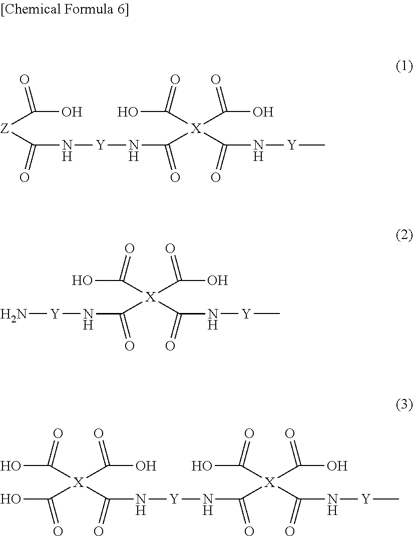

In the general formulas (1)-(3), X is a tetracarboxylic acid dianhydride residue, and Y is a diamine residue. In the general formula (1), Z is an acid anhydride residue, and is a divalent organic group.

The terminal structure of the general formula (2) is an amine terminal (identical to the above general formula (Q)) contained in a general polyamide acid. However, the acid anhydride end cap structure of the general formula (1), and the hydrolytically ring-opened terminal structure of the general formula (3) are structures that are not contained in a polyamide acid obtained only from a reaction between a tetracarboxylic acid dianhydride and a diamine. That is, one feature of the polyamide acid composition of the embodiment of the present invention is that, in addition to a polyamide acid having an amine terminal contained in a general polyamide acid, a polyamide acid having a terminal structure represented by the general formula (1) and a polyamide acid having a terminal structure represented by the general formula (3) are included.

Two terminal structures of a polyamide acid molecule may be the same or different. Although also depending on charge ratios of raw materials and reaction conditions, in general, the polyamide acid composition is a mixture of polyamide acids having identical terminal structures and polyamide acids having different terminal structures. That is, the polyamide acid composition includes: a polyamide acid of which both terminals have structures represented by the general formula (1); a polyamide acid of which both terminals have structures represented by the general formula (2); a polyamide acid of which both terminals have structures represented by the general formula (3); a polyamide acid of which one terminal has a structure represented by the general formula (1) and the other terminal has a structure represented by the general formula (2); a polyamide acid of which one terminal has a structure represented by the general formula (1) and the other terminal has a structure represented by the general formula (3); and a polyamide acid of which one terminal has a structure represented by the general formula (2) and the other terminal has a structure represented by the general formula (3).

A terminal structure of the general formula (1) is formed, for example, by a reaction of an amine terminal of a polyamide acid or an amino group of a diamine with an acid anhydride. A terminal structure of the general formula (3) is formed, for example, by a depolymerization reaction of a polyamide acid in the presence of water (first mode; cooking reaction), or a reaction of an amine terminal of a polyamide acid or a diamine with a single ring-opened compound of a tetracarboxylic acid dianhydride (second mode).

In the following, a structure of a polyamide acid is described in more detail with reference to a method for producing a polyamide acid. As described above, a polyamide acid is obtained by an addition reaction between a tetracarboxylic acid dianhydride and a diamine.

<Tetracarboxylic Acid Dianhydride>

Examples of tetracarboxylic acid dianhydrides include aromatic cyclic tetracarboxylic acid dianhydrides such as 3,3′,4,4′-biphenyl tetracarboxylic acid dianhydride (hereinafter, may be abbreviated as BPDA), pyromellitic acid dianhydride, 3,3′,4,4′-benzophenone tetracarboxylic acid dianhydride, 2,3,3′,4′-biphenyl tetracarboxylic acid dianhydride, 3,3′,4,4′-diphenyl sulfone tetracarboxylic acid dianhydride, 1,4,5,8-naphthalene tetracarboxylic acid dianhydride, 2,3,6,7-naphthalene tetracarboxylic acid dianhydride, 1,2,5,6-naphthalene tetracarboxylic acid dianhydride, 4,4′-oxydiphthalic acid anhydride, 9,9-bis(3,4-dicarboxyphenyl) fluorene dianhydride, 9,9′-bis[4-(3,4-dicarboxyphenoxy) phenyl] fluorene dianhydride, 3,3′,4,4′-biphenyl ether tetracarboxylic acid dianhydride, 2,3,5,6-pyridine tetracarboxylic acid dianhydride, 3,4,9,10-perylene tetracarboxylic acid dianhydride, 4,4′-sulfonyldiphthalic acid dianhydride, paraterphenyl-3,4,3′,4′-tetracarboxylic acid dianhydride, metaterphenyl-3,3′,4,4′-tetracarboxylic acid dianhydride, and 3,3′,4,4′-diphenyl ether tetracarboxylic acid dianhydride. An aromatic ring of a tetracarboxylic acid dianhydride may have a substituent such as an alkyl group, a halogen, or a halogen-substituted alkyl group.

A tetracarboxylic acid dianhydride may be an alicyclic tetracarboxylic acid dianhydride. Examples of alicyclic tetracarboxylic acid dianhydrides include cyclohexane tetracarboxylic acid dianhydride, bicyclo [2.2.2] octane-2,3,5,6-tetracarboxylic acid dianhydride, 5-(dioxotetrahydrofuryl-3-methyl-3-cyclohexene-1,2-dicarboxylic acid anhydride, 4-(2,5-dioxotetrahydrofuran-3-yl)-tetralin-1,2-dicarboxylic acid anhydride, tetrahydrofuran-2,3,4,5-tetracarboxylic acid dianhydride, bicyclo-3,3′,4,4′-tetracarboxylic acid dianhydride, 1,2,3,4-cyclopentane tetracarboxylic acid dianhydride, 1,2,3,4-cyclobutane tetracarboxylic acid dianhydride, 1,3-dimethyl-1,2,3,4-cyclobutane tetracarboxylic acid dianhydride, 1,4-dimethyl-1,2,3,4-cyclobutane tetracarboxylic acid dianhydride, and the like.

Two or more of these tetracarboxylic acid dianhydrides may be used in combination. In order to obtain a polyimide film having a low linear expansion coefficient, a tetracarboxylic acid dianhydride residue (X) preferably has a rigid structure. Therefore, it is preferable that an aromatic cyclic tetracarboxylic acid dianhydride be used as a raw material of a polyamide acid, and it is preferable that 95 mol % or more of tetracarboxylic acid dianhydrides be aromatic cyclic. Among aromatic cyclic tetracarboxylic acid dianhydrides, from a point of view of having a hight rigidity and allowing a polyimide film to have a low thermal expansion coefficient, BPDA or pyromellitic acid dianhydride is preferable, and BPDA is particularly preferable. It is preferable that 95 mol % or more of tetracarboxylic acid dianhydrides be BPDA.

<Diamine>

Examples of diamines include aromatic cyclic diamines such as paraphenylene diamine (hereinafter, may be abbreviated as PDA), 4,4′-diaminobenzidine, 4,4″-diaminoparaterphenyl, 4,4′-diaminodiphenyl ether, 3,4′-diaminodiphenyl ether, 4,4′-diaminodiphenyl sulfone, 1,5-bis(4-aminophenoxy) pentane, 1,3-bis(4-aminophenoxy)-2,2-dimethylpropane, 2,2-bis(4-aminophenoxyphenyl) propane, bis [4-(4-aminophenoxy) phenyl] sulfone, bis[4-(3-aminophenoxy) phenyl] sulfone, 2,2-bis(trifluoromethyl) benzidine, 4,4′-diaminobenzanilide, 9,9′-(4-aminophenyl) fluorene, and 9,9′-(4-amino-3-methylphenyl) fluorene; and alicyclic diamines such as 1,4-cyclohexane diamine, and 4,4′-methylenebis (cyclohexanamine).

Two or more of these diamines may be used in combination. In order to obtain a polyimide film having a low linear expansion coefficient, a diamine residue (Y) preferably has a rigid structure. Therefore, it is preferable that an aromatic cyclic diamine be used as a raw material of a polyamide acid, and it is preferable that 95 mol % or more of diamines be aromatic cyclic. Among aromatic cyclic diamines, from a point of view of having a hight rigidity and allowing a polyimide film to have a low thermal expansion coefficient, PDA or 4,4″-diaminoparaterphenyl is preferable, and PDA is particularly preferable. It is preferable that 95 mol % or more of diamines be PDA.

<Polymerization Reaction: Reaction Between Tetracarboxylic Acid Dianhydride and Diamine>

A polyamic acid is obtained by causing a tetracarboxylic acid dianhydride to react with a diamine in an organic solvent.

The organic solvent is not particularly limited as long as the organic solvent does not interfere with the polymerization reaction. It is also possible to use a mixed solvent of 2 or more organic solvents. As the solvent used in the polymerization of the polyamide acid, polar solvents are preferable, and among them, amide-based solvents such as N,N-dimethylformamide, N,N-dimethylacetamide and N-methyl-2-pyrrolidone are preferable. When N-methyl-2-pyrrolidone is used as the solvent, the storage stability of the polyamide acid solution tends to be high and the linear expansion coefficient of the polyimide film tends to be low. A main component of the organic solvent used in the polymerization of the polyamide acid is preferably an amide-based solvent. When the organic solvent is a mixed solvent, preferably, 50-100% by weight of the entire solvent is an amide-based solvent, and more preferably, 70-100% by weight of the entire solvent is an amide-based solvent.

In polymerization of a polyamide acid, it is preferable to cause a diamine in an excessive amount to react with a tetracarboxylic acid dianhydride. A polyamide acid obtained by a reaction between a tetracarboxylic acid dianhydride and a diamine in equimolar amounts contains the amine terminal structure represented by the above general formula (Q) and the acid anhydride terminal structure represented by the above general formula (R) in equimolar amounts. When a total mole number (y) of the diamine is larger than a total mole number (x) of the tetracarboxylic acid dianhydride, a ratio of the amine terminal structure in the obtained polyamide acid is increased.

From a point of view of increasing the ratio of the amine terminal structure, a ratio (x/y) of the total mole number (x) of the tetracarboxylic acid dianhydride to the total mole number (y) of the diamine is preferably 0.999 or less. The smaller the ratio (x/y) (the more excessive the amount of the diamine relative to the tetracarboxylic acid dianhydride), the smaller the ratio of the polyamide acid of the acid anhydride terminal structure. On the other hand, when the ratio (x/y) is too small, the molecular weight of the polyamide acid is small, and mechanical strength of a polyimide film obtained from the polyamide acid may be insufficient. Therefore, the ratio (x/y) is preferably 0.980 or more.

A concentration of the polyamide acid in a polyamide acid solution (total charge concentration of the diamine and the tetracarboxylic acid dianhydride) is preferably 5-30% by weight, more preferably 8-25% by weight, and even more preferably 10-20% by weight. When the charge concentration is within the above range, the polymerization reaction easily proceeds, and gelation due to abnormal polymerization of undissolved raw materials is suppressed.

From a point of view of increasing a polymerization reaction speed and suppressing depolymerization, a reaction temperature (temperature of the solution) is preferably 0° C.-80° C., and more preferably 20° C.-60° C. A reaction device is preferably provided with a temperature adjustment device.

<Cooking: Depolymerization by Heating in Presence of Water>

In the first mode, a depolymerization reaction (hydrolysis of an amide bond) of the polyamide acid is performed in the presence of water. By hydrolysis of the amide bond (Y—NH—CO—X), amine (Y—NH₂) and carboxylic acid (X—COOH) are formed. As a result, a polyamide acid having a terminal hydrolytically ring-opened structure represented by the above general formula (3) is produced.

From a point of view of promoting a hydrolysis reaction, an amount of water in the solution is preferably 500 ppm or more with respect to the polyamide acid. From a point of view of enhancing storage stability of the solution after the reaction, the amount of water with respect to the polyamide acid is preferably 12,000 ppm or less, and more preferably 5,000 ppm or less. As the water, water contained in the solvent may be used. When an amount of water in the solvent is within the above range, it is not necessary to add water to the system.

The depolymerization reaction is preferably carried out at a temperature higher than that of the polymerization of the polyamide acid, and the temperature of the solution is, for example, 70-100° C., and preferably 80-95° C. When heating temperature is low, progress of the depolymerization reaction becomes slow. When the heating temperature is too high, it may cause imidization of the polyamide acid to progress simultaneously with hydrolysis and cause a decrease in solubility in the solvent.

In this way, the process in which the solution is heated in the presence of water is an operation called “cooking,” promotes depolymerization of the polyamide acid and deactivation of the tetracarboxylic acid dianhydride, and can adjust the polyamide acid solution to have a viscosity (molecular weight) suitable for operations such as liquid feeding and coating. Cooking is preferably carried out until a weight average molecular weight of the polyamide acid is in a range of 40,000-150,000. The cooking reaction is terminated by cooling the solution. In this case, the temperature of the solution is preferably 30° C. or lower.

It is also possible that the polymerization of the polyamide acid by the reaction between the tetracarboxylic acid dianhydride and the diamine and the depolymerization by cooking are carried out in parallel. For example, it is also possible that the polymerization reaction and the cooking are performed all at once by setting the reaction temperature to about 70-100° C. after the organic solvent and the diamine and the tetracarboxylic acid dianhydride are mixed and before the viscosity has sufficiently increased. However, when the polymerization reaction and the cooking are carried out at the same time, unreacted tetracarboxylic acid dianhydride is likely to be deactivated. Therefore it is preferable to carry out cooking by raising the temperature of the solution after the polymerization reaction.

<Addition of Acid Anhydride: Introduction of Acid Anhydride End Cap Structure>

By adding an acid anhydride to the system, the acid anhydride reacts with an amino group of the diamine or an amine terminal of the polyamide acid, and a polyamide acid having an acid anhydride end cap structure represented by the general formula (1) is produced. The timing of adding the acid anhydride is not particularly limited, and the acid anhydride may be added during the polymerization reaction between the diamine and the tetracarboxylic acid dianhydride, or may be added during the cooking reaction, or may be added after the cooking reaction is completed.

An acid dianhydride is a compound represented by the following general formula (C), wherein Z is an acid anhydride residue. The acid anhydride residue is a portion other than an acid anhydride group (—CO—O—CO—) in the compound of the general formula (C), and is a divalent organic group.

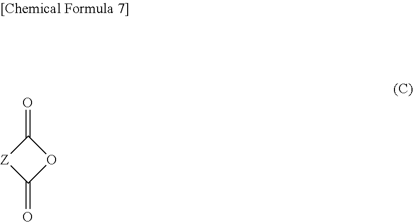

An example of the acid anhydride is a dicarboxylic acid anhydride. Specific examples of the dicarboxylic acid anhydride include aromatic cyclic acid anhydrides such as phthalic anhydride, 1,2-naphthalene dicarboxylic acid anhydride, 2,3-naphthalene dicarboxylic acid anhydride, 1,8-naphthalene dicarboxylic acid anhydride, 2,3-biphenyl dicarboxylic acid anhydride, and 3,4-biphenyl dicarboxylic acid anhydride. A substituent may be introduced to an aromatic ring of an aromatic cyclic acid anhydride. The substituent is preferably inactive with respect to an amino group, a carboxyl group, and a dicarboxylic acid anhydride group, and specific examples thereof include an alkyl group, a halogen, a halogen-substituted alkyl group, an ethynyl group, and the like. The acid anhydride may also be a non-aromatic acid anhydride such as 1,2,3,6-tetrahydrophthalic anhydride, 1,2-cyclohexane dicarboxylic acid anhydride, nazic acid anhydride, methyl-5-norbornene-2,3-dicarboxylic acid anhydride, citracon acid anhydride, or maleic anhydride. Among the acid anhydrides exemplified above, the aromatic cyclic acid anhydrides are preferable, and, among them, phthalic anhydride is particularly preferable. Two or more of these acid anhydrides may be used in combination.

<Charge Ratios of Raw Materials>

As described above, in the first mode, by the polymerization reaction between the diamine and the tetracarboxylic acid dianhydride, the cooking (for example, a process of keeping at 70-100° C. in the presence of water at 500-12,000 ppm with respect to the polyamide acid), and carrying out an end cap using an acid anhydride (a reaction between an acid anhydride and an amine terminal in the diamine or the polyamide acid), a polyamide acid composition having a terminal structure represented by the general formula (1), a terminal structure represented by the general formula (2), and a terminal structure represented by the general formula (3) is obtained. More specifically, a polyamide acid having a terminal structure represented by the general formula (3) is produced by the cooking, and a polyamide acid having a terminal structure represented by the general formula (1) is produced by the end cap using an acid anhydride.

As described above, the ratio (x/y) of the total mole number (x) of the tetracarboxylic acid dianhydride to the total mole number (y) of the diamine is less than 1, preferably 0.980-0.999, and more preferably 0.990-0.998. When the ratio (x/y) is 0.999 or less, a residual amount of an acid anhydride terminal represented by the above general formula (R) can be reduced. When the ratio (x/y) is 0.980 or more, the molecular weight of the polyamide acid can be increased, and high mechanical strength can be imparted to a polyimide film obtained by imidizing the polyamide acid. From a point of view of increasing the mechanical strength of the polyimide film, the ratio (x/y) may be 0.993 or more, or 0.995 or more.

The ratio (z/y) of the total mole number (z) of the acid anhydride to the total mole number (y) of the diamine is preferably 0.002-0.080, more preferably 0.002-0.040, and even more preferably 0.004-0.020. When the ratio (z/y) is too small, introduction of the end cap structure is insufficient, and an amino group is likely to remain at a terminal of the polyimide, and thus, free ions may adversely affect electrical characteristics such as an electrical resistivity and a dielectric constant. When the ratio (z/y) is too larger, the amount of the amine terminal (the terminal structure of the above general formula (2)) is smaller than the amount of the hydrolytically ring-opened terminal (the terminal structure of the above general formula (3)) in the polyamide acid composition, and it is difficult for the molecular weight to increase during the imidization, and thus, the mechanical strength of the polyimide film may be insufficient.

As will be described in detail later, during thermal imidization, the hydrolytically ring-opened terminal represented by the general formula (3) is cyclodehydrated to produce an acid anhydride, and the molecular weight is increased by a reaction between this acid anhydride terminal and the amine terminal represented by the general formula (2), and thus, the mechanical strength of the polyimide film is improved. In order to promote an increase in molecular weight during imidization, a ratio of the mole number of the terminal structure of the general formula (2) to the mole number of the terminal structure of the general formula (3) in the polyamide acid composition is preferably close to 1. In order for this ratio to be close to 1, a ratio of the total mole number (2y) of the amino group of the raw materials used to produce the polyamide acid to the total mole number (2x+z) of the acid dianhydride group is preferably close to 1. From a point of view of promoting an increase in molecular weight during imidization and reducing the amount of the amine terminal in the polyimide, the ratio ((2x+z)/(2y)) of the mole number of the acid anhydride group to the total mole number of the amino group is preferably 0.990-1.020, more preferably 0.995-1.015, and even more preferably 0.997-1.010.

<Introduction of Hydrolytically Ring-Opened Terminal by Single Ring-Opened Compound of Tetracarboxylic Acid Dianhydride>

In above first mode, an example is illustrated in which a polyamide acid having the hydrolytically ring-opened terminal represented by the general formula (3) is produced by depolymerization of a polyamide acid by cooking. In the second mode, a terminal structure represented by the general formula (3) is introduced by a single ring-opened compound of the tetracarboxylic acid dianhydride.

The single ring-opened compound of the tetracarboxylic acid dianhydride is a compound represented by the following general formula (D), in which only one of two acid anhydride groups of the tetracarboxylic acid dianhydride is opened to form a dicarboxylic acid. The X in the general formula (D) is a tetracarboxylic acid dianhydride residue.

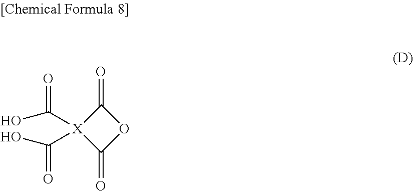

A single ring-opened compound of a tetracarboxylic acid dianhydride can be obtained by hydrolysis of the tetracarboxylic acid dianhydride. For example, a single ring-opened compound can be obtained by heating a tetracarboxylic acid dianhydride in a solvent containing a small amount of water. Specifically, hydrolysis is performed by keeping a solution containing a tetracarboxylic acid dianhydride and water at 500-6,000 ppm with respect to the tetracarboxylic acid dianhydride at a temperature of about 70-100° C.

Similar to the first mode, also in the second mode, polymerization of a tetracarboxylic acid dianhydride and a diamine in an organic solvent and introduction of an acid anhydride end cap structure are performed. In addition to this, in the second mode, a reaction between an amine terminal of a polyamide acid or an amino group of a diamine and an acid anhydride group of a single ring-opened compound of a tetracarboxylic acid dianhydride is performed. As a result of this reaction, a polyamide acid having a terminal hydrolytically ring-opened structure represented by the above general formula (3) is produced.

The timing of adding the single ring-opened compound of the tetracarboxylic acid dianhydride is not particularly limited. For example, in the polymerization reaction, in addition to the diamine and the tetracarboxylic acid dianhydride, the single ring-opened compound of the tetracarboxylic acid dianhydride may be added. In this case, it is preferable to dissolve the diamine in the organic solvent and then add the single ring-opened compound of the tetracarboxylic acid dianhydride prepared in advance in addition to the tetracarboxylic acid dianhydride and the acid anhydride. Further, it is also possible that the diamine and the acid anhydride are added to a solution of the single ring-opened compound of the tetracarboxylic acid dianhydride.

Also in the second mode, similar to the first mode, depolymerization of a polyamide acid by cooking may be performed. In this case, by a reaction between the single ring-opened compound of the tetracarboxylic acid dianhydride and an amino group and hydrolysis of an amide group of a polyamide acid, a polyamide acid having a terminal hydrolytically ring-opened structure represented by the general formula (3) is produced.

Preferable ranges of the ratios (x/y) and (z/y) of the charged amounts of the components in the second mode are the same as those in the first mode. However, in the second mode, the total mole number (x) is a sum of a total mole number (x₁) of the tetracarboxylic acid dianhydride and a total mole number (x₂) of the single ring-opened compound of the tetracarboxylic acid dianhydride.

<Abundance Ratios of Residues in Polyamide Acid Composition>

Since the terminal structures are controlled, the polyamide acid composition has excellent storage stability and handleability, and, since the molecular weight is increased in the imidization, the polyimide film has excellent mechanical strength.

The amount of the tetracarboxylic acid anhydride residue (X) in the polyamide acid obtained in the first mode and the second mode is equal to the total mole number (x) of the tetracarboxylic acid dianhydride (in the second mode, the sum of the single ring-opened compound of the tetracarboxylic acid anhydride and the tetracarboxylic acid dianhydride). The amount of the diamine residue (Y) is equal to the total mole number (y) of the diamine, and the amount of the acid anhydride residue (Z) is equal to the total mole number (z) of the acid anhydride.

Therefore, for the polyamide acid composition, the ratio (x/y) of the total mole number (x) of the tetracarboxylic acid dianhydride residue (X) to the total mole number (y) of the diamine residue (Y) is less than 1, preferably 0.980-0.999, and more preferably 0.990-0.998. When the ratio (x/y) is in this range, high mechanical strength can be imparted to a polyimide film obtained by imidizing the polyamide acid. The ratio (z/y) of the total mole number (z) of the acid anhydride residue (Z) to the total mole number (y) of the diamine residue (Y) is preferably 0.002-0.080, more preferably 0.002-0.040, and even more preferably 0.004-0.020. When the ratio (z/y) is in this range, a polyimide film that has excellent mechanical strength and a small amine terminal amount and is less affected by free ions is obtained. The ratio ((2x+z)/(2y)) is preferably 0.990-1.020, more preferably 0.995-1.015, and even more preferably 0.997-1.010.

<Alkoxysilane Terminal Polyamide Acid>

A polyamide acid composition of an embodiment of the present invention may include other terminal structures in addition to the terminal structures of the general formulas (1)-(3). In an embodiment, a polyamide acid composition has a terminal structure (alkoxysilane terminal) represented by a general formula (4) in addition to the terminal structures of the general formulas (1)-(3).

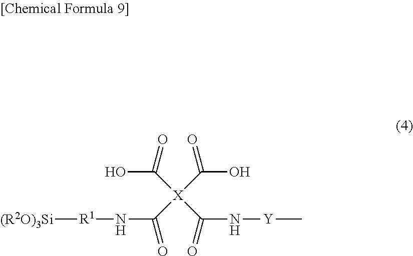

In the general formula (4), R¹ is a divalent organic group, preferably a phenylene group or an alkylene group having 1-5 carbon atoms. R² is an alkyl group, X is a tetracarboxylic acid dianhydride residue, and Y is a diamine residue.

A polyamide acid composition having a terminal structure represented by the general formula (4) can be obtained by causing an alkoxysilane compound containing an amino group to react with a polyamide acid in a solution. It is also possible that an alkoxysilane compound containing an amino group is added to a polyamide acid composition having terminal structures represented by the general formulas (1)-(3), and a terminal is modified.

When an alkoxysilane compound having an amino group is added to a polyamide acid obtained by causing a diamine in an excessive amount to react with a tetracarboxylic acid dianhydride, viscosity of the polyamide acid solution tends to decrease. It is presumed that this is because an acid anhydride group produced by the depolymerization of the polyamide acid reacts with the amino group of the alkoxysilane compound, and a modification reaction proceeds, and the molecular weight of the polyamide acid decreases. From a point of view of facilitating a modification reaction while suppressing a reaction between the acid dianhydride group and water, a reaction temperature for the modification by the alkoxysilane compound containing an amino group is preferably 0-80° C., and more preferably 20-60° C.

An alkoxysilane compound containing an amino group is represented by the following general formula (E). R¹ and R² in the general formula (E) are the same as in the general formula (4).

[Chemical Formula 10]

(R²O)₃Si—R¹—NH₂ (E)

R¹ may be any divalent organic group. However, from a point of view of having a high reactivity with an acid anhydride group of a polyamide acid, a phenylene group or an alkylene group having 1-5 carbon atoms is preferable, and among them, an alkylene group having 1-5 carbon atoms is preferable. R² may be any alkyl group having 1-5 carbon atoms. However, a methyl group or an ethyl group is preferable, and, from a point of view of improving adhesion between the polyamide acid and a glass, a methyl group is preferable.

Specific examples of the alkoxysilane compound having an amino group include 3-aminopropyltrimethoxysilane, 3-aminopropyltriethoxysilane, 3-aminopropylmethyldimethoxysilane, 3-aminopropylmethyldiethoxysilane, 3-aminopropylmethyldimethoxysilane, 3-(2-aminoethyl) aminopropyltrimethoxysilane, 3-phenylaminopropyltrimethoxysilane, 2-aminophenyltrimethoxysilane, and 3-aminophenyltrimethoxysilane.

A ratio (α/x) of a total mole number (α) of the alkoxysilane compound having an amino group to the total mole number (x) of the tetracarboxylic acid dianhydride is preferably 0.0001-0.0050, more preferably 0.0005-0.0050, and even more preferably 0.0010-0.0030. When the ratio (α/x) is 0.0001 or more, an effect is achieved that adhesion between an inorganic substrate such as a glass and the polyimide film is improved and spontaneous peeling is suppressed. When the ratio (α/x) is 0.0100 or less, since the molecular weight of the polyamide acid can be maintained, the storage stability of the polyamide acid solution is excellent and the mechanical strength of the polyimide film can be ensured.

A weight-average molecular weight of the polyamide acid composition is preferably 10,000-200,000, more preferably 20,000-150,000, and even more preferably 30,000-100,000. When the weight average molecular weight is 200,000 or less, the viscosity of the polyamide acid solution is low and applicability to operations such as liquid feeding and coating is excellent. When the weight average molecular weight is 10,000 or more, a polyimide film having excellent mechanical strength can be obtained. The weight average molecular weight of the polyamide acid composition may be 40,000 or more, 50,000 or more, or 60,000 or more. The weight average molecular weight of the polyamide acid composition may be 90,000 or less, 80,000 or less, or 70,000 or less.

[Polyamide Acid Solution]

A solution after the above-described reaction (a solution obtained by dissolving the polyamide acid composition in an organic solvent) can be used as it is as a polyamide acid solution for producing a polyimide film. For a purpose of adjusting the viscosity, an organic solvent may be added or removed. As the solvent, in addition to N,N-dimethylformamide, N,N-dimethylacetamide and N-methyl-2-pyrrolidone exemplified above as solvents for the polymerization reaction, dimethyl sulfoxide, 3-methoxy-N, N-dimethylpropanamide, hexamethylphosphoride, acetonitrile, acetone, and tetrahydrofuran can be used. Xylene, toluene, benzene, diethylene glycol ethyl ether, diethylene glycol dimethyl ether, 1,2-bis-(2-methoxyethoxy) ethane, bis(2-methoxyethyl) ether, butyl cellosolve, butyl cellosolve acetate, propylene glycol methyl ether, propylene glycol methyl ether acetate or the like may be combinedly used as an auxiliary solvent.

<Additives>

The polyamide acid solution may contain various additives. For example, the polyamide acid solution may contain a surface conditioner for a purpose of defoaming the solution, improving surface smoothness of the polyimide film, or the like. As the surface conditioner, any surface conditioner having an appropriate compatibility with a polyamide acid and a polyimide and having a defoaming property may be selected. From a point of view that a harmful substance is unlikely to be generated during high temperature heating, acrylic compounds, silicone compounds and the like are preferable, and, from a point of view of having excellent recoatability, acrylic compounds are particularly preferable.

Specific examples of surface conditioners formed of acrylic compounds include DISPARLON LF-1980, LF-1983, LF-1985 (manufactured by Kusumoto Kasei Co., Ltd.), BYK-3440, BYK-3441, BYK-350, BYK-361N (manufactured by BYK Japan Co., Ltd.) and the like.

An additive amount of a surface conditioner with respect to 100 parts by weight of the polyamide acid is preferably 0.0001-0.1 parts by weight, and more preferably 0.001-0.1 parts by weight. When the additive amount is 0.0001 parts by weight or more, a sufficiently effect in improving surface smoothness of the polyimide film can be achieved. When the additive amount is 0.1 parts by weight or less, turbidness is unlikely to occur in the polyimide film. A surface conditioner may be directly added to the polyamide acid solution, or may be diluted with a solvent and then added to the polyamide acid solution. Timing of adding a surface conditioner is not particularly limited. A surface conditioner may be added during polymerization or terminal modification of the polyamide acid. When alkoxysilane modification is performed, a surface conditioner may be added after the alkoxysilane modification.

The polyamide acid solution may contain inorganic fine particles and the like. Examples of inorganic fine particles include inorganic oxide powders such as fine-particulate silicon dioxide (silica) powder and aluminum oxide powder, and inorganic salt powders such as fine-particulate calcium carbonate powder and calcium phosphate powder. Presence of coarse grains formed by agglomeration of fine particles may cause defects in the polyimide film. Therefore, the inorganic fine particles are preferably uniformly dispersed in the solution.

When the imidization of the polyamide acid is performed by chemical imidization, the polyamide acid solution may contain an imidization catalyst. As the imidization catalyst, tertiary amines are preferable, and among them, heterocyclic tertiary amines are preferable. Preferable specific examples of heterocyclic tertiary amines include pyridine, 2,5-diethylpyridine, picoline, quinoline, isoquinoline, and the like. From a point of view of a catalytic effect and cost, a usage amount of the imidization catalyst is about 0.01-2.00 equivalents, and preferably 0.02-1.20 equivalents with respect to the amide group of the polyamide acid which is a polyimide precursor. From a point of view of enhancing the storage stability of the solution, an imidization catalyst may be added to the polyamide acid solution immediately before the polyamide acid solution is used (is applied on a substrate).

<Water Content of Polyamide Acid Solution>

The polyamide acid solution has a water content of, for example, 2,000 ppm-5,000 ppm. When the water content is 5,000 ppm or less, the polyamide acid solution tends to have excellent storage stability. The storage stability tends to improve as the water content of the polyamide acid solution decreases. Water in the solution can be roughly divided into a part originated from the raw materials and a part originated from the environment. An example of the water originated from the raw materials is water produced by the imidization (the cyclodehydration reaction of the polyamide acid). For example, when a polyamide acid solution of a solid content concentration of 15% containing BPDA and PDA is 30% imidized, the water content in the solution is increased by about 4,000 ppm. In order to reduce the water content of the solution below that level, there will be an increase in cost. Therefore, the water content of the polyamide acid solution may be in the above range. As a method for reducing the water content, it is effective to strictly perform raw material storage to avoid mixing of water, and to replace a reaction atmosphere with dry air, dry nitrogen, or the like. Further, processing may be performed under a reduced pressure.

[Polyimide Film]

By applying the polyamide acid solution on a substrate and performing imidization, a laminate in which a polyimide film is adhesively laminated on the substrate is obtained. As the substrate, an inorganic substrate is preferable. Examples of inorganic substrates include a glass substrate and various metal substrates. When the polyimide film is a substrate of a flexible device, from a point of view that conventional device manufacturing equipment can be directly used, a glass substrate is preferable. Examples of glass substrates include soda lime glass, borosilicate glass, alkali-free glass, and the like. In particular, alkali-free glass generally used in a manufacturing process of a thin film transistor is preferable. From a point of view of handleability and heat capacity of a substrate, a thickness of an inorganic substrate is preferably about 0.4-5.0 mm.

As a method for applying the solution, commonly known application methods such as a gravure coating method, a spin coating method, a silk screen method, a dip coating method, a bar coating method, a knife coating method, a roll coating method and a die coating method can be applied.

The imidization may be any one of chemical imidization using a cyclodehydration agent (imidization catalyst) and thermal imidization in which an imidization reaction is caused to proceed by heating only without an action of a cyclodehydration agent or the like. From a point of view of having less residual impurities such as cyclodehydration agent ressidues, the thermal imidization is preferable. Heating temperature and heating time in the thermal imidization can be appropriately determined, for example, as follows.

First, in order to vaporize the solvent, heating is performed at a temperature of 100-200° C. for 3-120 minutes. Heating can be performed under air, under a reduced pressure or in an inert gas such as nitrogen. As a heating device, a hot air oven, an infrared oven, a vacuum oven, a hot plate or the like may be used. After the solvent is vaporized, in order for the imidization to further proceed, heating is performed at a temperature of 200-500° C. for 3-300 minutes. The heating temperature is preferably gradually increased from a low temperature to a high temperature, and a maximum temperature is preferably in a range of 300-500° C. When the maximum temperature is 300° C. or higher, the thermal imidization tends to proceed easily, and the mechanical strength of the obtained polyimide film tends to improve. When the maximum temperature is 500° C. or lower, thermal degradation of the polyimide can be suppressed.

The polyimide film preferably has a thickness of 5-50 μm. When the thickness of the polyimide film is 5 μm or more, a required mechanical strength for a substrate film can be ensured. When the thickness of the polyimide film is 50 μm or less, spontaneous peeling of the polyimide film from the inorganic substrate tends to be suppressed.

The polyamide acid composition having the terminal structures of the above general formulas (1)-(3) tends to have a high molecular weight after the thermal imidization. Therefore, even when the polyamide acid has a small weight average molecular weight, a polyimide film having high mechanical strength can be obtained. Although the polyamide acid composition has the amine terminal of the general formula (2), the hydrolytically ring-opened terminal of the general formula (3) hardly reacts with the amine terminal in a storage environment of the polyamide acid solution. Therefore, the polyamide acid solution has excellent storage stability.

The hydrolytically ring-opened terminal of the general formula (3) is cyclodehydrated by heating during the thermal imidization to become an acid anhydride group, which reacts with the amine terminal of the general formula (2) to form an amide bond, and an imide bond is formed by cyclodehydration. That is, during the thermal imidization, the polyamide acid having the terminal structure of the general formula (3) and the polyamide acid having the terminal structure of the general formula (2) react with each other to increase the molecular weight. Therefore, even when the molecular weight of the polyamide acid is low, due to the increase in the molecular weight during the thermal imidization, a polyimide film having excellent mechanical strength can be obtained.

Due to the reaction between the terminal of the general formula (2) and the terminal of the general formula (3) during the imidization, the obtained polyimide has a higher ratio of the acid anhydride end-cap terminal of the general formula (1) and a lower ratio of the amine terminal or the acid (anhydride) terminal as compared to the polyamide acid. That is, for the polyimide, since the terminals are capped and an amount of reactive functional groups (the amino group, the carboxy group, and the acid anhydride group) is small, chemical stability is high and there is less influence on electric characteristics by free ions and the like.

The polyimide film is obtained by peeling off the polyimide film from the laminate of the substrate such as glass and the polyimide film. From a point of view of suppressing deformation of the polyimide film or an element formed thereon due to a tension during the peeling, peel strength when the polyimide film is peeled off from the laminate of the glass substrate and the polyimide film is preferably 1 N/cm or less, more preferably 0.5 N/cm or less, and even more preferably 0.3 N/cm or less. On the other hand, from a point of view of suppressing spontaneous peeling of the polyimide film from the glass substrate, the peel strength is preferably 0.01 N/cm or more, more preferably 0.3 N/cm or more, and even more preferably 0.5 N/cm or more.

Breaking strength of the polyimide film is preferably 350 MPa or more, more preferably 400 MPa or more, and even more preferably 450 MPa or more. When the breaking strength is in the above range, even when the film has a small thickness, it is possible to prevent the polyimide film from breaking during the processes such as transportation and peeling from the inorganic substrate. From the same point of view, breaking elongation of the polyimide film is preferably 15% or more, more preferably 20% or more, and even more preferably 25% or more. The breaking elongation may also be 30% or more. Upper limits of the breaking strength and the breaking elongation of the polyimide film are not particularly limited. The breaking strength may be 600 MPa or less. The breaking elongation may be 80% or less, or 60% or less.

The polyimide film preferably has a linear thermal expansion coefficient of 10 ppm/° C. or less. When the linear thermal expansion coefficient is 10 ppm/° C. or less, the polyimide film can also be suitably used as a substrate of a flexible device in which element formation is performed at a high temperature. The linear thermal expansion coefficient of the polyimide film may also be 9 ppm/° C. or less, or 8 ppm/° C. or less. The linear thermal expansion coefficient of the polyimide film may also be 1 ppm/° C. or more.

[Formation of Electronic Element on Polyimide Film]

When the polyimide film is used as a substrate for a flexible device or the like, an electronic element is formed on the polyimide film. The electronic element may be formed on the polyimide film before the polyimide film is peeled off from the inorganic substrate such as a glass. That is, the electronic element is formed on the polyimide film of the laminate in which the polyimide film is adhesively laminated on the inorganic substrate such as a glass, and then the polyimide film on which the electronic element is formed is peeled off from the inorganic substrate, and thereby, a flexible device is obtained. This process has an advantage that existing production equipment using an inorganic substrate can be directly used, and is useful for producing an electronic device such as a flat panel display, or an electronic paper, and is also suitable for mass production.

A method for peeling off the polyimide film from the inorganic substrate is not particularly limited. For example, the polyimide film may be peeled off by hand, or may be peeled off using a mechanical device such as a drive roll or a robot. A release layer may be provided between the inorganic substrate and the polyimide film, or a treatment for reducing adhesion between the inorganic substrate and the polyimide film may be performed before the peeling. Specific examples of methods for reducing the adhesion include a method in which a silicon oxide film is formed on an inorganic substrate having a large number of grooves and peeling is performed by immersion in an etching solution; and a method in which an amorphous silicon layer is provided on an inorganic substrate and separation is performed using laser.

### EXAMPLES

In the following, the present invention is specifically described based on examples. However, the present invention is not limited to these examples.

[Evaluation Methods]

<Water Content>

The water content in a solution was measured using a volumetric titration Karl Fischer water content analyzer (“890 Titrando” manufactured by Metrohm Japan) according to a volumetric titration method of JIS K0068. However, when a resin was precipitated in a titration solvent, a 1:4 mixed solution of Aquamicron GEX (manufactured by Mitsubishi Chemical Co., Ltd.) and N-methylpyrrolidone was used as a titration solvent.

<Viscosity>

The viscosity was measured using a viscometer (“RE-215/U” manufactured by Toki Sangyo Co., Ltd.) according to JIS K7117-2: 1999. An attached thermostatic bath was set to 23.0° C. and a measurement temperature was always kept constant.

<Weight Average Molecular Weight>

The weight average molecular weight was measured using gel permeation chromatography (GPC). A GPC system equipped with CO-8020, SD-8022, DP-8020, AS-8020 and RI-8020 (all manufactured by Tosoh Corporation), two columns of Shoudex: GPC KD-806M (8 mmΦ×30 cm) were used as columns, and one GPC KD-G (4.6 mmΦ×1 cm) was used as a guard column. An RI was used as a detector. As an eluent, a solution prepared by dissolving 30 mM LiBr and 30 mM phosphoric acid in DMF was used. Measurement was performed under conditions including a solution concentration of 0.4% by weight, an injection volume of 30 μL, an injection pressure of about 1.3-1.7 MPa, a flow rate of 0.6 mL/min, and a column temperature of 40° C., and the weight-average molecular weight was calculated based on a calibration curve prepared using polyethylene oxide as a standard sample.

<Peel Strength>

A cut having a width of 10 mm was made with a cutter knife into a polyimide film adhesively laminated on a glass plate in accordance with the ASTM D1876-01 standard, and the polyimide film was peeled off 50 mm from the glass plate using a tensile tester (“Strograph VES1D” manufactured by Toyo Seiki Co., Ltd.) in an environment of 23° C. and 55% RH at a tensile speed of 50 mm/min and a peeling angle of 90 degrees, and an average value of peeling strength was defined as the peel strength.

<Breaking Strength and Breaking Elongation>

A test piece was prepared by cutting a polyimide film into a width of 15 mm and a length of 150 mm, and two parallel marking lines separated by 50 mm were marked at a center of the test piece. A tensile test was performed in accordance with JIS K7127: 1999 using a tensile tester (“UBFA-1 AGS-J” manufactured by Shimadzu Corporation) at a tensile speed of 10 mm/min and a stress (breaking strength) and an elongation (breaking elongation) when the test piece broke were determined.

<Linear Expansion Coefficient>

A test piece was prepared by cutting a polyimide film into a width of 3 mm and a length of 10 mm, and a thermomechanical analysis based on a tensile load method was performed using a thermo-mechanical analyzer (“TMA/SS120CU” manufactured by SII Nano Technology Co., Ltd.) by applying a load of 29.4 mN to a long side of the test piece. First, temperature was raised from 20° C. to 500° C. at 100° C./min (first heating), and lowered to 20° C., and then, raised to 500° C. at 10° C./min (second heating). An amount of change in strain of the test piece per unit temperature in a range of 100° C.-300° C. during the second heating was defined as the linear expansion coefficient.

### Example 1

<Polymerization of Polyamide Acid and Cooking>

850.0 g of N-methyl-2-pyrrolidone (NMP) was charged into a glass separable flask having a capacity of 2 L equipped with a stirrer, a stirring blade and a nitrogen inlet tube, the stirrer having a polytetrafluoroethylene sealing plug; 40.1 g of paraphenylene diamine (PDA) and 0.6 g of 4,4′-diaminodiphenyl ether (ODA) were added; and the mixture was stirred for 30 minutes under a nitrogen atmosphere while being heated in an oil bath at 50° C. After confirming that the raw materials were uniformly dissolved, 109.4 g of 3,3′,4,4′-biphenyltetracarboxylic acid dianhydride (BPDA) was added. A solid content concentration (sum of the diamines (PDA and ODA) and the tetracarboxylic acid dianhydride (PDA)) of this reaction solution was 15% by weight, and a ratio (x/y) of the total mole number (x) of the tetracarboxylic acid dianhydride to the total mole number (y) of the diamines was 0.995.

After BPDA was added, while the mixture was stirred under a nitrogen atmosphere, the temperature of the solution was raised from 50° C. to about 90° C. in 10 minutes, and the raw materials were completely dissolved. Further, while heating at 90° C., stirring was continued for 3 hours to carry out a cooking reaction to reduce the viscosity of the solution. The solution after the cooking reaction had a viscosity of 20,000 mPa·s at 23° C.

<Modification using Alkoxysilane Compound>

The above reaction solution was quickly cooled in a water bath, and the temperature of the solution was adjusted to about 50° C., and then, 7.50 g of 1% NMP solution of 3-aminopropyltriethoxysilane (γ-APS) was added and the mixture was stirred for 3 hours. After that, NMP was added to dilute the solution, and an alkoxysilane-modified polyamide acid solution having a viscosity of 3,500 mPa·s at 23° C. was obtained. The ratio (α/x) of the total mole number (α) of the alkoxysilane compound to the total mole number (x) of the tetracarboxylic acid dianhydride was 0.001.

To the obtained solution, an acrylic surface conditioner (“BYK-361N” manufactured by BYK Japan Co., Ltd.) was added in an amount of 0.02 parts by weight with respect to 100 parts by weight of a solid content of the alkoxysilane-modified polyamide acid, and was uniformly dispersed, and an alkoxysilane-modified polyamide acid solution containing a surface conditioner was obtained.

<End Cap using Phthalic Anhydride>

0.55 g of phthalic anhydride was added to the above alkoxysilane-modified polyamide acid solution, and the solution was stirred in a nitrogen atmosphere for 60 minutes while being heated to 50° C. in an oil bath. After confirming that the raw material was uniformly dissolved, the mixture was cooled, and a polyamide acid solution having a viscosity of 3,950 mPa·s at 23° C. was obtained. The ratio (z/y) of the total mole number (z) of the acid anhydride (phthalic anhydride) to the total mole number (y) of the diamine was 0.010.

### Example 2 and Example 3

In the end cap using phthalic anhydride, a charge amount of phthalic anhydride was changed as shown in Table 1. A polyamide acid solution was obtained in the same manner as in Example 1 except for the above change.

### Example 4

The capacity of the separable flask was changed to 500 mL, the charge amount of NMP was changed to 255 g, and the charge amounts of PDA, ODA and BPDA were changed as shown in Table 1. The polymerization of the polyamide acid and the cooking reaction were carried out in the same manner as in Example 1 except for the above changes. After that, the temperature of the solution was adjusted to about 50° C., and 2.20 g of 1% NMP solution of γ-APS was added to perform alkoxysilane modification, and an acrylic surface conditioner in an amount of 0.02 parts by weight with respect to 100 parts by weight of a solid content of the alkoxysilane-modified polyamide acid was added. 0.34 g of phthalic anhydride was added to this alkoxysilane-modified polyamide acid solution, and the solution was stirred for 60 minutes in a nitrogen atmosphere at 50° C., and a polyamide acid solution was obtained.

### Comparative Example 1

The same amounts of NMP, PDA, ODA and BPDA as in Example 4 were charged into a separable flask. After BPDA was charged, the mixture was stirred under a nitrogen atmosphere at 50° C. for 60 minutes until the raw materials were completely dissolved. After that, without heating, the polymerization reaction was terminated without carrying out a cooking reaction. After that, in the same manner as in Example 4, alkoxysilane modification and end cap using phthalic anhydride were performed, and a polyamide acid solution was obtained.

### Comparative Examples 2, 3

The charge amount of BPDA in the polymerization of the polyamide acid and the charge amount of phthalic anhydride in the end cap using phthalic anhydride were changed as shown in Table 1. A polyamide acid solution was obtained in the same manner as in Comparative Example 1 except for the above changes.

[Production of Polyimide Film]

The obtained polyamide acid solution was applied on a square alkali-free glass plate for a FPD having a thickness of 0.7 mm and sides of 150 mm (“Eagle XG” manufactured by Corning Co., Ltd.) using a bar coater such that a thickness after drying was about 15 and was dried in a hot air oven at 120° C. for 30 minutes. After that, under a nitrogen atmosphere, the temperature was raised from 20° C. to 120° C. at a rate of 7° C./minute and from 120° C. to 450° C. at a rate of 7° C./minute, and heating was performed at 450° C. for 10 minutes, and a laminate of a polyimide film and an alkali-free glass plate was obtained.

Table 1 shows the charge amounts of the raw materials in the synthesis of the polyamide acid in the examples and the comparative examples, and whether or not the cooking reaction was performed. Table 2 shows the charge ratios of the raw materials in the synthesis of polyamide acid, the characteristics of the polyamide acid solution, and the evaluation results of the polyimide film.

TABLE 1

| | | | | | | | Alkoxysilane | | End Cap | | | |
|---|---|---|---|---|---|---|---|---|---|---|---|---|
| | Polymerization and Cooking | | | | | | Modification | | Phthalic | | | |
| | PDA | ODA | BPDA | | | | γ-APS | | Anhydride | | Viscosity before | Viscosity after |
| | g | g | g | | | Viscosity | g | | g | | Reaction | Reaction |
| | mmol | mmol | mmol | x/y | Cooking | mPa · s | mmol | α/x | mmol | z/y | mPa · s | mPa · s |
| Example 1 | 40.1 | 0.60 | 109.4 | 0.995 | Yes | 20,000 | 0.075 | 0.001 | 0.55 | 0.010 | 3,500 | 3,950 |
| | 371 | 3.0 | 372 | | | | 0.42 | | 3.7 | | | |
| Example 2 | 40.1 | 0.60 | 109.4 | 0.995 | Yes | 20,000 | 0.075 | 0.001 | 0.27 | 0.005 | 3,500 | 4,100 |
| | 371 | 3.0 | 372 | | | | 0.42 | | 1.8 | | | |
| Example 3 | 40.1 | 0.60 | 109.4 | 0.995 | Yes | 20,000 | 0.075 | 0.001 | 0.12 | 0.002 | 3,500 | 3,950 |
| | 371 | 3.0 | 372 | | | | 0.42 | | 0.8 | | | |
| Example 4 | 12.1 | 0.18 | 32.8 | 0.990 | Yes | 24,000 | 0.022 | 0.001 | 0.34 | 0.020 | 4,050 | 4,050 |
| | 112 | 0.9 | 111 | | | | 0.12 | | 2.3 | | | |
| Comparative | 12.1 | 0.18 | 32.8 | 0.990 | No | 50,000 | 0.022 | 0.001 | 0.34 | 0.020 | 3,950 | 3,950 |
| Example 1 | 112 | 0.9 | 111 | | | | 0.12 | | 2.3 | | | |
| Comparative | 12.1 | 0.18 | 32.7 | 0.985 | No | 16,000 | 0.022 | 0.001 | 0.51 | 0.030 | 4,000 | 4,000 |
| Example 2 | 112 | 0.9 | 111 | | | | 0.12 | | 3.4 | | | |
| Comparative | 12.1 | 0.18 | 32.5 | 0.980 | No | 6,800 | 0.022 | 0.001 | 0.68 | 0.040 | 4,000 | 4,000 |
| Example 3 | 112 | 0.9 | 110 | | | | 0.12 | | 4.6 | | | |

TABLE 2

| | | | | | Polyamic Acid Characteristic | | | Polyimide Film | | | | |
|---|---|---|---|---|---|---|---|---|---|---|---|---|
| | | | | | | Water | | | Breaking | Breaking | Peel | Thermal Expansion |
| | Raw Material Charge Ratio | | | | Viscosity | Content | | Thickness | Strength | Elongation | Strength | Coefficient |
| | Cooking | x/y | z/y | α/x | mPa · s | ppm | Mw | μm | Mpa | % | N/cm | ppm/° C. |
| Example 1 | Yes | 0.995 | 0.010 | 0.001 | 3,950 | 2100 | 65,000 | 17 | 485 | 30 | 0.11 | 6 |
| Example 2 | Yes | 0.995 | 0.005 | 0.001 | 4,100 | 1900 | 67,000 | 16 | 480 | 28 | 0.12 | 5 |
| Example 3 | Yes | 0.995 | 0.002 | 0.001 | 3,950 | 2100 | 66,000 | 14 | 450 | 26 | 0.17 | 2 |
| Example 4 | Yes | 0.990 | 0.020 | 0.001 | 4,050 | 2500 | 68,000 | 16 | 400 | 20 | 0.19 | 4 |
| Comparative | No | 0.990 | 0.020 | 0.001 | 3,950 | 2500 | 78,300 | 14 | 320 | 9 | 0.10 | 7 |
| Example 1 | | | | | | | | | | | | |
| Comparative | No | 0.985 | 0.030 | 0.001 | 4,000 | 2400 | 70,000 | 13 | 310 | 8 | 0.51 | 2 |
| Example 2 | | | | | | | | | | | | |
| Comparative | No | 0.980 | 0.040 | 0.001 | 4,000 | 2600 | 55,000 | 13 | 260 | 5 | 0.34 | 3 |
| Example 3 | | | | | | | | | | | | |

In Examples 1-4, the polyimide film had an appropriate peeling strength with respect to the alkali-free glass plate, and spontaneous peeling during heating did not occur, and it was possible to peel off the polyimide film from the alkali-free glass plate.

The polyimide films of Examples 1-4 all had a breaking strength of 400 MPa or more and a breaking elongation of 20% or more, and exhibited higher mechanical strength than the polyimide films of Comparative Examples 1-3. Further, even though the polyamide acids of Examples 1-4 had lower molecular weights than the polyamide acids of Comparative Examples 1 and 2, the polyimide films of Examples 1-4 exhibited high mechanical strength.

The charge amounts of the raw materials were the same in Example 4 and Comparative Example 1, and the only difference between the two was the presence or absence of cooking after the polymerization of the polyamide acid. From these results, it is thought that, in Examples 1-4, due to the cooking after the polymerization of the polyamide acid, the polyamide acid depolymerized and the molecular weight was lowered, and a polyamic acid having the hydrolytically ring-opened terminal represented by the general formula (3) was produced, and the molecular weight was increased during the imidization. The polyimide films of Examples 1 3 had even higher mechanical strength than that of Example 4, and among them, Example 1 exhibited the highest mechanical strength.

From the above results, it can be seen that the polyamide acid composition having the terminal structures of the general formulas (1)-(3) is excellent in solution handleability due to its low molecular weight, and the polyimide film after imidization exhibits high mechanical strength, and a polyimide film having even more excellent mechanical strength can be obtained by adjusting the charge ratios of the raw materials during preparation of the polyamide acid.

1. A polyamide acid composition, comprising:
a polyamide acid having a terminal structure represented by a general formula (1);
a polyamide acid having a terminal structure represented by a general formula (2); and
a polyamide acid having a terminal structure represented by a general formula (3): 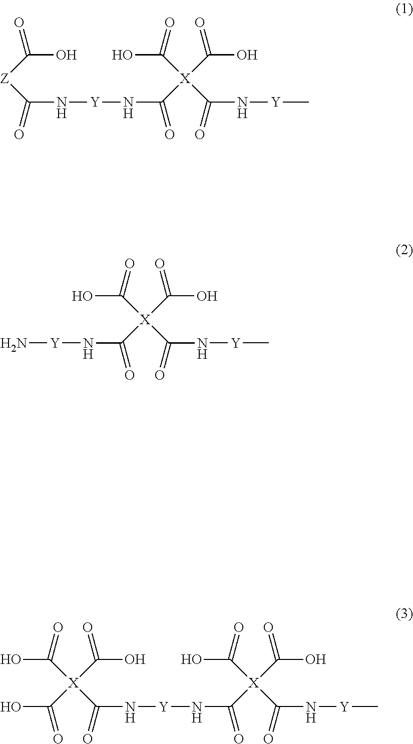
wherein X is a tetravalent organic group which is a tetracarboxylic acid dianhydride residue, Y is a divalent organic group which is a diamine residue, and Z is a divalent organic group which is an acid anhydride residue.

2. The polyamide acid composition according to claim 1, wherein
a ratio (x/y) of a total mole number (x) of the tetracarboxylic acid dianhydride residue (X) to a total mole number (y) of the diamine residue (Y) is 0.980-0.999, and
a ratio (z/y) of a total mole number (z) of the acid anhydride residue (Z) to the total mole number (y) of the diamine residue (Y) is 0.002-0.080.

3. The polyamide acid composition according to claim 1, further comprising:
a polyamide acid having a terminal structure represented by a general formula (4): 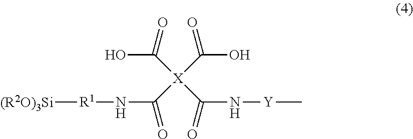
wherein R¹ is a divalent organic group, and R² is an alkyl group having 1-5 carbon atoms.

4. The polyamide acid composition according to claim 3, wherein
a ratio (x/α) of the total mole number (x) of the tetracarboxylic acid dianhydride residue (X) to a total mole number (α) of an alkoxysilyl group represented by a general formula (R²O)₃Si— is 0.0001-0.0100.

5. A method for producing the polyamide acid composition according to claim 1, comprising:
causing a polymerization reaction to occur between a diamine and a tetracarboxylic acid dianhydride in a solvent such that a solution of a polyamide acid is obtained;
depolymerizing the polyamide acid obtained by the polymerization reaction by heating the solution in presence of water; and
reacting a dicarboxylic acid anhydride with the diamine or an amine terminal of the polyamide acid depolymerized.

6. The method according to claim 5, wherein
a ratio (x/y) of a total mole number (x) of the tetracarboxylic acid dianhydride to a total mole number (y) of the diamine is 0.980-0.999, and
a ratio (z/y) of a total mole number (z) of the dicarboxylic acid anhydride to the total mole number (y) of the diamine is 0.002-0.080.

7. The method according to claim 5, wherein
the depolymerizing is conducted at a temperature of 70-100° C. in presence of 500-12000 ppm of the water with respect to the polyamide acid subject to the depolymerizing.

8. The method according to claim 5, further comprising:
reacting an alkoxysilane compound with the polyamide acid such that a terminal of a polyamide acid is alkoxysilane-modified.

9. A polyimide film, comprising:
a polyimide which is a cyclodehydration product of the polyamide acid composition of claim 1.

10. A laminate, comprising:
a substrate; and
the polyimide film of claim 9 adhesively laminated on the substrate.

11. A method for producing a laminate of a polyimide film and a substrate, comprising:
applying a solution of the polyamide acid composition of claim 1 on the substrate; and
imidizing a polyamide acid by cyclodehydrating the polyamide acid by heating such that the polyimide film is obtained and adhesively laminated on the substrate.

12. A flexible device,
the polyimide film of claim 9; and
an electronic element on the polyimide film.

13. The polyamide acid composition according to claim 2, further comprising:
a polyamide acid having a terminal structure represented by a general formula (4): 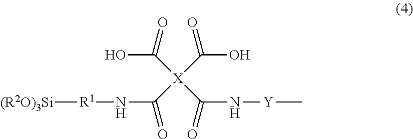
wherein R¹ is a divalent organic group, and R² is an alkyl group having 1-5 carbon atoms.

14. The method according to claim 6, wherein the depolymerizing is conducted at a temperature of 70-100° C. in presence of 500-12000 ppm of the water with respect to the polyamide acid.

15. The method according to claim 6, further comprising:
reacting an alkoxysilane compound with the polyamide acid such that a terminal of a polyamide acid is alkoxysilane-modified.

16. The method according to claim 7, further comprising:
reacting an alkoxysilane compound with the polyamide acid such that a terminal of a polyamide acid is alkoxysilane-modified.

17. The method according to claim 14, further comprising:
reacting an alkoxysilane compound with the polyamide acid such that a terminal of a polyamide acid is alkoxysilane-modified.

18. A polyimide film, comprising:
a polyimide which is a cyclodehydration product of the polyamide acid composition of claim 4.

19. A method for producing a laminate of a polyimide film and a substrate, comprising:
applying a solution of the polyamide acid composition of claim 3 on the substrate; and
imidizing a polyamide acid by cyclodehydrating the polyamide acid by heating such that the polyimide film is obtained and adhesively laminated on the substrate.

20. A method for producing a laminate of a polyimide film and a substrate, comprising:
applying a solution of the polyamide acid composition of claim 4 on the substrate; and
imidizing a polyamide acid by cyclodehydrating the polyamide acid by heating such that the polyimide film is obtained and adhesively laminated on the substrate.
